(19) United States
(12) Patent Application Publication
(10) Pub. No.: US 2007/0016331 A1
(43) Pub. Date: Jan. 18, 2007

(54) Method and system for generating combination of applications for building automation system

(75) Inventor: Andreas Fehr, Zurich (CH)

Correspondence Address: STAAS & HALSEY LLP, SUITE 700, 1201 NEW YORK AVENUE, N.W., WASHINGTON, DC, 20005, US

(73) Assignee: SIEMENS SCHWEIZ AG, Zurich (CH)

(21) Appl. No.: 11/485,343

(22) Filed: Jul. 13, 2006

Related U.S. Application Data
(60) Provisional application No. 60/730,884, filed on Oct. 28, 2005.

(30) Foreign Application Priority Data
Jul. 13, 2005 (EP) 05106405

(51) Int. Cl. G05B 15/00

(52) U.S. Cl. 700/275; 715/734

(57) ABSTRACT

Function groups are generated, each having at least two technical functions, interconnected by a data connection and which in their entirety include the technical functions of a combination of applications. A technical function is assigned to a device which belongs to the combination of applications and by which the technical function can be carried out. The combination of applications is assigned to a room template and a template of the combination of applications is generated. An engineering tool may be used to simplify preparation, installation and commissioning of networks with distributed regulator and control applications in a building.

### CROSS REFERENCE TO RELATED APPLICATIONS

This application is based on and hereby claims priority to European Application No. EP 05106405 filed on Jul. 13, 2006 and U.S. Provisional Application No. 60/730,884 filed on Oct. 28, 2005, the contents of which are hereby incorporated by reference.

### BACKGROUND OF THE INVENTION

1. Field of the Invention

The invention relates to a method and system suitable for example for the preparation, installation and commissioning of networks with distributed regulator and control applications in a building. Methods or systems of this type allow simplified network engineering for building automation systems.

2. Description of the Related Art

A building automation system is a system for monitoring, controlling and/or regulating process variables in complex technical systems in a building, or in an area including a number of buildings. By way of example, a building automation system operates heating, ventilation and air-conditioning systems, lighting and shading devices and also access, safety/security and fire monitoring systems. In the building automation system, process variables—such as for example air-conditioning variables or events—are sensed, evaluated, monitored, influenced or generated.

In a building automation system, generally a multiplicity of so-called field devices, such as sensors and actuators, have to be operated. Typical field devices of a building automation system are, for example, temperature and humidity sensors, air quality sensors, pressure sensors, flow meters, electricity meters, heat counters, heating water valves, thermostat valves, ventilation flaps, sprinkler valves, brightness sensors, fire detectors, intruder detectors, light switches, chip card readers and readers for sensing biometric data. Apart from the field devices, a building automation system generally includes a multiplicity of controlling and regulating devices and also further devices, for example devices for linking the building automation system to external communication networks, screens or devices for the analysis of video signals.

Furthermore an electrical or wireless communication medium is used in a building automation system for the data exchange between individual devices or system parts; in principle, cables, optical data communication channels, ultrasound connections, electromagnetic near fields or radio networks can be used, for example also an optical fiber network or a cellular telephone network. Technologies or standards which can be used for the data exchange are, for example, LON or LonWorks® of the company ECHELON, the European installation bus EIB, KONNEX, ZigBee or the PROFIBUS defined by the German standard DIN 19245.

Known methods for the preparation, installation and commissioning of networks with distributed regulator and control applications in a building have the disadvantage that they are labor-intensive and consequently also too time-consuming, and in particular can in each case only be carried out for individual rooms or zones of a building and not on a multi-zone or multi-room basis.

### SUMMARY OF THE INVENTION

The invention is based on an object of providing an improved and generally usable method for supporting an engineering process for preparation and installation of networks with distributed control and regulating applications in a building and of creating a system for carrying out the method.

### BRIEF DESCRIPTION OF THE DRAWINGS

These and other objects and advantages of the present invention will become more apparent and more readily appreciated from the following description of exemplary embodiments, taken in conjunction with the accompanying drawings of which:

FIG. 1 is a block diagram of a combination of applications for a building automation system, and

FIG. 2 is a block diagram of a template of a combination of applications and instances of the template assigned to room zones of a building.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

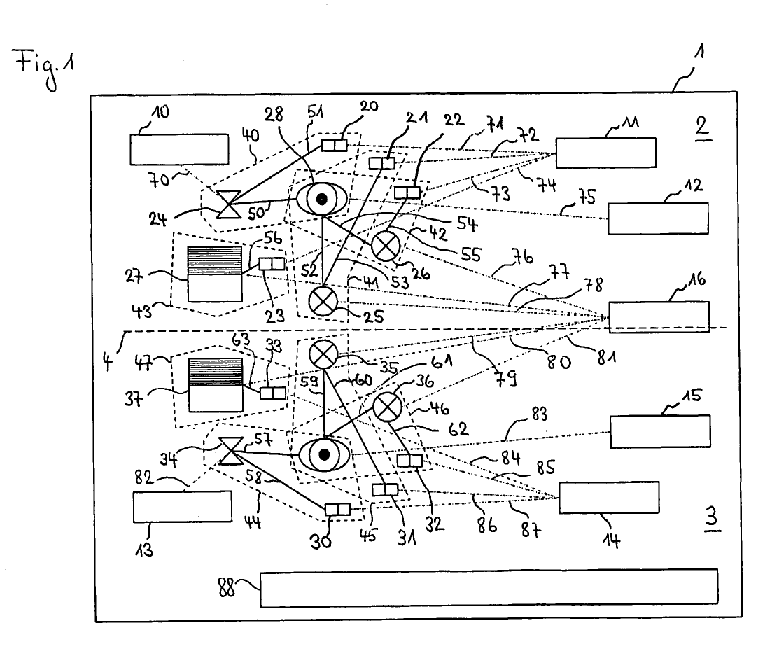

In FIG. 1, 1 designates a room template including a first room zone 2 and a second room zone 3. The two room zones 2 and 3 are separated by a dividing wall 4.

In the first room zone 2, devices 10, 11 and 12 of a building automation system are arranged. The second room zone 3 has devices 13, 14 and 15 of the building automation system. A further device 16 is arranged here on a multi-zone basis, for example in a false floor, in the two room zones 2 and 3.

Devices here are typically field devices, that is sensors and actuators, or else control and regulating devices. The devices are in principle hardware units for which application programs are capable of running and/or the components of which can be operated by application programs and/or the properties of which the application programs influence. The devices are integrated in the building automation system by data communication channels.

An application or an application program is software by which a specific technical functionality of a typically universally usable hardware is defined.

In the exemplary embodiment represented, a first device 10 and a second device 13 are each a control and regulating device, by which a room temperature can be regulated, and which controls heating water valves and a fan-type convector. A third device 11 and a fourth device 14 are each a universally usable operating device capable of communication, with a display and a number of keys. A fifth device 12 and a sixth device 15 are each a movement sensor unit. A seventh device 16 is a universal control and regulating device, which can be used for controlling lighting and blinds.

The first room zone 2 can be operated by the building automation system with technical functions 20, 21, 22, 23, 24, 25, 26, 27 and 28, while the second room zone 3 can be operated by the building automation system with technical functions 30, 31, 32, 33, 34, 35, 36, 37 and 38.

Here, a technical function is a partial task or activity which is automatically performed or carried out by the building automation system. Technical functions are, for example, a user interface, heating, ventilation and room air-conditioning regulation, room occupancy monitoring, room lighting control, shading regulation, which can be achieved for example by use of sunblind, security lighting control, a fire detection function, an intruder detecting device, a sprinkler activity, an evacuation support activity or access control.

In the exemplary embodiment represented, the first room zone 2 can be operated by the following technical functions:

a first user interface 20 for the activation of a heating, ventilation and room air-conditioning regulation 24; a second user interface 21 for the activation of a first room lighting control 25; a third user interface 22 for the activation of a second room lighting control 26; a fourth user interface 23 for the activation of a shading control 27, room occupancy monitoring 28.

The technical functions in the second room zone 3 are: a fifth user interface 30 for the activation of a further heating, ventilation and room air-conditioning regulation 34; a sixth user interface 31 for the activation of a third room lighting control 35; a seventh user interface 32 for the activation of a fourth room lighting control 36; and an eighth user interface 33 for the activation of a further shading control 37; further room occupancy monitoring 28.

According to the invention, a method for generating a combination of applications includes the four-part method presented below:

First, function groups are generated, each having at least two technical functions interconnected by a data connection and in their entirety including the technical functions of the combination of applications. With one function group, all the data connections between the technical functions of the function group, and consequently the logical interrelationship within the function group, are defined. For the generation of a function group, in principle two different method variants can be carried out:

In a first method variant, a function group is automatically generated by connecting technical functions, connecting a first technical function to a second technical function being brought about by defining a data connection between the first technical function and the second technical function. A function group generated in this way is advantageously also stored in a function group library.

In a second method variant, a predetermined function group, having technical functions and necessary data connections between the technical functions, is selected from the function group library. The technical function can advantageously be allocated as and when required to a number of technical functions.

Next in the method a technical function is assigned a device by which the technical function can be carried out in an application program capable of running on the device. With an assignment that is made possible in principle on a multi-room basis, optimum utilization of the devices is also made possible.

At the end of the method, the combination of applications is assigned to a room template, which depicts at least two room zones of a building and a template of the combination of applications is generated.

The method may be applied to the situation represented in the drawing to give rise to the following exemplary embodiment:

At the beginning of the method, function groups 40, 41, 42, 43, 44, 45, 46 and 47 are generated. For this purpose, in principle the two method variants mentioned above can be carried out.

In a first function group 40, the first user interface 20, the heating, ventilation and room air-conditioning regulation 24 and the room occupancy monitoring 28 are grouped together. This includes a grouping of technical functions that logically belong together, which can finally make possible a room air-conditioning regulation application which is dependent on the current room occupancy situation and in which, for example, the setpoint temperature can be changed via a user interface.

In a second function group 41, the second user interface 21, the first room lighting control 25 and the room occupancy monitoring 28 are grouped together. In a third function group 42, the third user interface 22, the second room lighting control 26 and the room occupancy monitoring 28 are grouped together. In a fourth function group 43, the fourth user interface 23 and the shading control 27 are grouped together. The fifth user interface 30, the further heating, ventilation and room air-conditioning regulation 34 and the further room occupancy monitoring 38 are grouped together to form a fifth function group 44. The sixth user interface 31, the third room lighting control 35 and the further room occupancy monitoring 38 are grouped together to form a sixth function group 45. The seventh user interface 32, the fourth room lighting control 36 and the further room monitoring 38 are grouped together to form a seventh function group 46. Finally, the eighth user interface 33 and the further shading control 37 are grouped together to form an eighth function group 47.

To generate the function groups, data connections 50, 51, 52, 53, 54, 55, 56, 57, 58, 59, 60, 61, 62 and 63 for each connecting two technical functions are defined, with the purpose of making possible a function-related data exchange between the connected technical functions.

The heating, ventilation and room air-conditioning regulation 24 is connected via a first data connection 50 to the room monitoring 28 and via a second data connection 51 to the first user interface 20. The two data connections 50 and 51 allow data to be exchanged within the first function group 40.

The first room lighting control 25 is connected via a third data connection 52 to the room monitoring 28 and via a fourth data connection 53 to the second user interface 21. In the same way, a fourth data connection 54 is defined between the second room lighting control 26 and the room monitoring 28 and a sixth data connection 55 is defined between the second room lighting control 26 and the third user interface 22. The shading control 27 and the fourth user interface 23 are connected to each other by defining a seventh data connection 56.

The further heating, ventilation and room air-conditioning regulation 34 is connected via an eighth data connection 57 to the further room monitoring 38 and via a ninth data connection 58 to the fifth user interface 30. The two data connections 57 and 58 allow data to be exchanged within the fifth function group 44.

The third room lighting control 35 is connected via a tenth data connection 59 to the further room monitoring 38 and via an eleventh data connection 60 to the sixth user interface 31. In the same way, the twelfth data connection 61 is defined between the fourth room lighting control 36 and the further room monitoring 38 and a thirteenth data connection 62 is defined between the fourth room lighting control 36 and the seventh user interface 32. The further shading control 37 and the eighth user interface 33 are connected to each other by defining a fourteenth data connection 63.

The method continues by carrying out assignments 70, 71 to 87, linking technical functions to devices by which the assigned technical functions are carried out.

A first assignment 70 links the heating, ventilation and air-conditioning regulation 24 to the first device 10. The second device 11 is linked via a second assignment 71 to the first user interface 20, by a third assignment 72 to the second user interface 21, a fourth assignment 73 to the third user interface 22 and a fifth assignment 74 to the fourth user interface 23. A sixth assignment 75 links the room monitoring 28 to the third device 12. The seventh device 16 is linked by a seventh assignment 76 to the second room lighting control 26, by an eighth assignment 77 to the shading control 27, by a ninth assignment 78 to the first room lighting control 25, a tenth assignment 79 to the third room lighting control 35, an eleventh assignment 80 to the further shading control 37 and, finally, by a twelfth assignment 81 to the fourth room lighting control 36. A thirteenth assignment 82 links the further heating, ventilation and air-conditioning regulation 34 to the fourth device 13. A fourteenth assignment 83 links the further room monitoring 15 to the sixth device 15. The fifth device 14 is linked via a fifteenth assignment 84 to the eighth user interface 33, by a sixteenth assignment 85 to the seventh user interface 32, a seventeenth assignment 86 to the sixth user interface 31 and an eighteenth assignment 87 to the fifth user interface 30.

An application program of a device respectively carries out all the technical functions assigned to the device. The application program capable of running on the device is consequently described by the entirety of the technical functions assigned to the device.

The application program of the seventh device 16, for example, carries out the four room lighting controls 25, 26, 35 and 36 that are assigned to the device 16 and also carries out the two shading controls 27 and 37.

The application program of the fifth device 12, to give a further example, carries out exclusively the room occupancy monitoring 28 assigned to the fifth device 12.

The combination of applications is then assigned to the room template 1. The room template 1 is a template for a building zone including two room zones. The room template 1 typically reflects a portion of a certain building that occurs multiply in the building concerned. The room template 1 for example reflects a building zone including two office workplaces on the south front or the east front of the building, the influences to be expected on the south front and east front, such as for example heat and light irradiation, being taken into account in the combination of applications assigned to the template 1. The room template 1 can consequently be used for a number of identical portions of the building.

Finally, the template is generated for the combination of applications generated previously and the combination of applications is advantageously assigned an identification 88. The template of the combination of applications is a template for generating instances of the combination of applications for a building zone corresponding to the room template 1.

A possibly necessary amendment of the combination of applications can advantageously be carried out by a one-off alteration of the template of the combination of applications, whereby all the existing instances can also be automatically assimilated to the template by an inheritance mechanism.

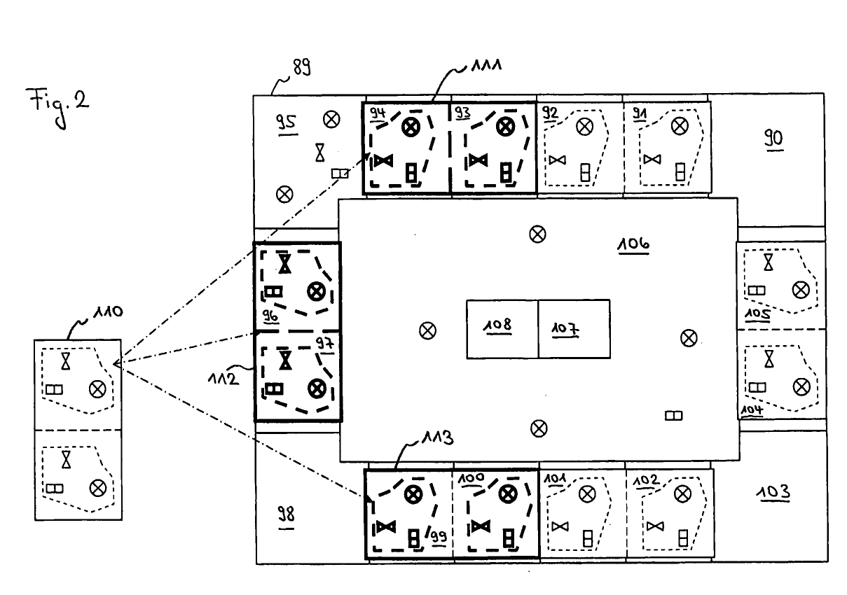

In FIG. 2, 89 designates a story of a building which has room zones 90, 91, 92 to 108. A first instance 111, a second instance 112 and a third instance 113 have been generated for a template 110 of a further combination of applications. The first instance 111 is correspondingly assigned to the room template of the combination of applications of a room zone 93 and a room zone 94. In the same way, the second instance 112 is assigned to a room zone 96 and a room zone 97 and the third instance 113 is assigned to a room zone 99 and a room zone 100.

After an alteration of the template 110, for example after an exchange of a technical function, the three instances 111, 112 and 113 can also be automatically assimilated to the template by an inheritance mechanism.

The proposed method for generating a combination of applications including a number of devices and also a number of technical functions is advantageously implemented as a computer-aided interactive engineering tool. The engineering tool operating by the proposed method makes possible an automatically verifiable design, installation and commissioning of networks with distributed regulator and control applications for building automation systems.

The engineering tool advantageously has a microcomputer unit—for example a personal computer—having an input/output device, which unit is programmed in such a way that a room division of a building and also devices arranged in the building of a building automation system, such as sensors, actuators, control and regulating devices, can be represented. The engineering tool has software for creating a combination of applications of the building automation system including a number of devices and also a number of functions, which performs the method of:
generating function groups which each have at least two technical functions interconnected by a data connection and which in their entirety include the technical functions of the combination of applications,
assigning a technical function to a device by which the technical function can be carried out,
assigning the combination of applications to a room template having at least two room zones, and
generating a template of the combination of applications.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A method for generating a combination of applications including a number of devices and a number of technical functions for a building automation system, comprising:
generating function groups, each of which have at least two technical functions interconnected by a data connection, the groups including all of the technical functions of the combination of applications;
assigning a technical function to a device which belongs to the combination of applications and by which the technical function can be carried out;
assigning the combination of applications to a room template depicting at least two room zones; and
generating a template of the combination of applications.

2. The method as claimed in claim 1, wherein said generating of the function groups includes generating a function group by connecting a first technical function to a second technical function by defining a data connection between the first technical function and the second technical function.

3. The method as claimed in claim 2, further comprising assigning a technical function to a number of function groups.

4. The method as claimed in claim 3, further comprising assigning a number of technical functions to a device.

5. The method as claimed in claim 4, further comprising generating an instance of the combination of applications for a building zone corresponding to the room template.

6. The method as claimed in claim 5, further comprising:
altering the template of the combination of applications; and
assimilating existing instances of the template by inheritance after said altering.

7. The method as claimed in claim 1, further comprising selecting a predetermined function group, having technical functions and necessary data connections between the technical functions, from a function group library.

8. A system for generating a representation of a building automation system with a room division of a building and devices arranged in the building, including at least one of sensors, actuators, control and regulating devices, comprising:
an input/output device; and
a microcomputer unit, coupled to the input/output device, programmed to create a combination of applications of the building automation system including a number of devices and a number of functions in response to instructions received from the input/output device, by generating function groups which each have at least two technical functions interconnected by a data connection and which in their entirety include the technical functions of the combination of applications, assigning a technical function to a device by which the technical function can be carried out, assigning the combination of applications to a room template having at least two room zones, and generating a template of the combination of applications.

9. The system as claimed in claim 8, wherein said microcomputer unit is further programmed to generate an instance of the combination of applications for a building zone corresponding to the room template.

10. The system as claimed in claim 8, wherein said microcomputer unit is further programmed to alter the template of the combination of applications in response to instructions received from the input/output device.

11. The system as claimed in claim 10, wherein said microcomputer unit is further programmed to alter instances of the altered template in a way corresponding to the altered template.
